(19) United States
(12) Patent Application Publication
(10) Pub. No.: US 2008/0112343 A1
(43) Pub. Date: May 15, 2008

(54) TREATMENT OF SECONDARY MANAGEMENT DATA AS USER DATA IN AN IEEE 802.16 SYSTEM SCHEDULER

(75) Inventor: Antoni OLESZCZUK, Calgary (CA)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/751,200

(22) Filed: May 21, 2007

Related U.S. Application Data
(60) Provisional application No. 60/865,461, filed on Nov. 13, 2006.

(51) Int. Cl. H04B 7/00

(52) U.S. Cl. 370/310

(57) ABSTRACT

A method of processing secondary management data packets, and a scheduler to perform the method, including processing each of the secondary management data packets through one or more queues in the scheduler used to process a user service flow in an Institute of Electrical and Electronics Engineers 802.16 system.

### CROSS-REFERENCE TO RELATED APPLICATIONS

This application is based on, and claims the benefit of, U.S. Provisional Application No. 60/865,461, filed Nov. 13, 2006, inventor Antoni Oleszczuk, attorney docket number 1974.1017P, and which is incorporated herein by reference.

### BACKGROUND OF THE INVENTION

### DESCRIPTION OF THE RELATED ART

Wireless communication networks have become increasingly popular in modern communication applications. Particularly, wireless communication networks based on the Institute of Electrical and Electronics Engineers (IEEE) 802.16 standard have become the focus of a great deal of interest and research, with several institutions and corporations committing various resources to developing applications of the IEEE 802.16 standard. One such application of the IEEE 802.16 standard has become known as WiMAX. WiMAX is defined as Worldwide Interoperability for Microwave Access by the WiMAX Forum, formed in June 2001 to promote conformance and interoperability of the IEEE 802.16 standard, officially known as WirelessMAN. The Forum describes WiMAX as “a standards-based technology enabling the delivery of last mile wireless broadband access as an alternative to cable and DSL”. The bandwidth and reach of WiMAX make it suitable for connecting Wi-Fi hotspots with each other and to other parts of the Internet, providing a wireless alternative to cable and DSL for last mile broadband access, and providing high-speed mobile data and telecommunications services.

The media access control (MAC) service of an IEEE 802.16 implementation is connection oriented. The MAC scheduler of an IEEE 802.16 station, such as, for example, a base station, a mobile station, relay station, etc., schedules outgoing service connections, which are typically user service flow connections or management connections, according to the types and attributes of the data packets being transmitted. The management connections typically carry only management messages, or data, while the user service flow connections carry other traffic, normally user data.

In order to efficiently allocate available resources of the system, the MAC scheduler schedules user data packets to user service flow connections according to defined quality of service (QoS) parameters of the data packets. Typically, however, management connections are scheduled simply according to the type of management connection. Conventionally, there are three types of these management connections: basic management connections; primary management connections; and secondary management connections, although there may be other more specialized management connections.

Of the aforementioned management connections, the basic and primary management connections are typically defined by the IEEE 802.16 implementation, while the secondary management connections are typically provided for user defined connections. In other words, the secondary management connections are typically defined by whatever type of application is being used with the IEEE 802.16 implementation at the time. The data packets transmitted in the three types of management connections are placed in corresponding respective queues in the scheduler according to the management connection type of the management connection. The scheduling of the data packets in user data connections is typically performed by placing the data packets in corresponding respective queues in the scheduler according to the QoS parameters of the data packets.

FIG. 1 illustrates a scheduler 100 used in an IEEE 802.16 implementation. For the sake of simplicity, only a few of the more pertinent queues are illustrated in this figure. For example, the scheduler 100 of FIG. 1 includes a latency queue 110, a minimum reserved traffic rate queue 120, a secondary management queue 130, and a best effort queue 140. Queues for basic and primary management connections, as well as for other user data connections with different QoS parameters, which may also be included in the scheduler 100, are not shown for the sake of simplicity.

As can be understood from the illustration of the scheduler 100, user data packets having a defined latency parameter are placed in the latency queue 110, user data packets having a defined minimum reserved traffic rate parameter are placed in the minimum reserved traffic rate queue 120, and user data packets having a defined best effort parameter, not having any defined QoS parameter, or perhaps having a defined QoS parameter not corresponding to other user data queues in the scheduler 100, may be placed in the best effort queue 140. Data packets for the secondary management connection are placed in the secondary management queue 130. The data packets of these various service connections are output according the priority of the queues, which is illustrated in FIG. 1 in a descending order from the latency queue 110 to the best effort queue 140. However, this priority order may be different in different implementations of the IEEE 802.16 standard.

Therefore, the scheduler of a conventional IEEE 802.16 implementation has several queues in which to place the data packets for various service connections. The high number of queues leads to complications such as increased complexity and slower processing time in the IEEE 802.16 system.

### SUMMARY OF THE INVENTION

Various embodiments of the present invention provide a method which includes placing a secondary management data packet in a best effort queue of a scheduler in an IEEE 802.16 system, and processing the secondary management data packet accordingly with other data packets in the best effort queue.

Various embodiments of the present invention provide a method which includes placing a secondary management data packet in a corresponding queue of a scheduler in an IEEE 802.16 system in response to the secondary management data packet having a defined QoS parameter, and processing the secondary management data packet according to the corresponding queue of the scheduler.

Various embodiments of the present invention provide a method of processing secondary management data packets including processing each of the secondary management data packets through one or more queues in a scheduler used to process a user service flow in an IEEE 802.16 system.

Various embodiments of the present invention provide a scheduler including a best effort queue in which service flow data packets having no defined QoS parameters are placed in an IEEE 802.16 system, wherein a secondary management data packet is placed in the best effort queue and processed accordingly with the service flow data packets in the best effort queue.

Various embodiments of the present invention provide a scheduler including a plurality of QoS specific queues to process data packets having defined QoS parameters in an IEEE 802.16 system, wherein a secondary management data packet is placed in a corresponding queue of the scheduler in response to the secondary management data packet having a defined QoS parameter.

Various embodiments of the present invention provide a scheduler including a plurality of queues to process a user service flow in an IEEE 802.16 system, wherein one or more secondary management data packets are each processed through one or more of the queues which process the user service flow.

The above-described embodiments of the present invention are intended as examples, and all embodiments of the present invention are not limited to including features described above.

### BRIEF DESCRIPTION OF THE DRAWINGS

FIG. 1 illustrates a scheduler in a conventional IEEE 802.16 implementation;

FIG. 2 is a flow chart illustrating a method of scheduling a secondary management data packet according to an embodiment of the present invention;

FIG. 3 is a flow chart illustrating a method of scheduling a secondary management data packet according to another embodiment of the present invention; and

FIG. 4 illustrates a scheduler for a IEEE 802.16 implementation according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout.

Various embodiments of the present invention provide a method which includes placing a secondary management data packet in a best effort queue of a scheduler in an IEEE 802.16 system, and processing the secondary management data packet accordingly with other data packets in the best effort queue. Typically, user service flow data packets placed in a best effort queue are processed at a lower priority than data packets in other queues. In other words, the best effort queue conventionally has the lowest priority of all the user service flow queues, and therefore these data packets receive the best efforts of the scheduler available after processing the data packets of queues having a higher priority. The data packets may be placed in the various queues of the scheduler according to defined QoS parameters of the data packets. These QoS parameters indicate a minimum level of service desired in various qualities such as, for example, latency, minimum reserved traffic rate, etc. For example, if a user service flow data packet has a defined QoS parameter for latency, then that value is the largest value of latency that would be acceptable for the service flow transmitting that data packet. However, the present invention is not limited to any specific QoS parameters, or to the QoS parameters of latency, minimum reserved traffic rate, jitter, or others.

Thus, in an embodiment of the present invention, the secondary management data packet is not placed in a queue reserved for secondary management data connections, as in the conventional IEEE 802.16 system. Rather, the secondary management data packet may simply be placed in the best effort queue of the scheduler, which is already provided for scheduling service flow data packets that do not have defined QoS parameters that would cause the service flow data packets to be placed in other corresponding queues of the scheduler. Therefore, at least the secondary management queue can be eliminated from a scheduler using this method. Of course, this is merely an example embodiment of the present invention, and other various embodiments are not limited thereto.

Of the three conventional management connections, those being basic, primary and secondary, the basic and primary management connections are used for management issues defined by the IEEE 802.16 standard. The secondary management connection, however, even though called a management connection, is applicable only to the user defined application. In other words, the IEEE 802.16 standard does not specify what kind of messages, or data, are transmitted in the secondary management connection. The secondary management connection may be described as a special connection provided by the IEEE 802.16 standard that may be used to control a subscriber station in any proprietary way as assumed in a particular network implementation. For example, the IEEE 802.16 standard indicates that the secondary management connection of a subscriber station may be used to transport standards-based messages used to manage the subscriber station at a functional layer that is above that provided by the IEEE 802.16 standard. Some example standards that may be used for the secondary management messages are DHCP (Dynamic Host Configuration Protocol), TFTP (Trivial File Transfer Protocol), SNMP (Simple Network Management Protocol), etc., which are based on IP (Internet Protocol) standards (such as IPv4 or IPv6). The standard does not explicitly provision the nature of the messages sent on the secondary management connection, except that it suggest using these IP-based standards. The IEEE 802.16 standard provides a way to establish a secondary management connection and to define its QoS parameters, such as, for example, traffic priority, maximum sustained traffic rate, minimum reserved traffic rate, and latency.

As an example of the type of messages that might be transmitted in a secondary management connection, an IEEE 802.16 system may be implemented in a mobile telephone system. The IEEE 802.16 standard defines a process for how a mobile station, which may be a handheld phone, sends necessary messages to a base station to make a connection. Once the connection is established, two service flows are likely opened because there are transmissions in each direction between the base station and mobile station, and IEEE 802.16 system service flows are unidirectional. Therefore, two service flows may be opened for voice, for example, which will transmit the digitized-voice data between the stations. However, it is also necessary in a mobile system from time to time to issue messages that are specific to the mobile applications. Examples of these specific messages may include, for example, paging signals or handover support. Other examples may include inquiries as to the state of the mobile station. These kinds of messages might be used in secondary management data. The user layer of the base station and a special layer on top of the MAC on the mobile station communicate through the secondary management connection. In other words, they send special messages that are defined in the specific application. In another example, secondary management data may be used to configure mobile stations. This means that secondary management data is used to send the configuration files. Configuration files modify the behavior so that at the beginning of the connection a configuration file is sent to the mobile station, and the mobile station modifies its behavior based on the configuration file included in the secondary management data. This is very much different than the basic and primary management connections, which are for messages such as the “handshaking” imposed by the IEEE 802.16 standard itself. For example, during start-up an initial ranging message is sent through the basic management connection. When a mobile station notices a signal coming from a base station it engages in a message protocol which is called the initial ranging network. An operation such as this is not application specific, and therefore would not be handled through a secondary management connection.

Furthermore, in older editions of the IEEE 802.16 standard, there were no QoS parameters defined for the secondary management connections. However, in later revisions of the IEEE 802.16 standard such as, for example, the D5 WiMAX corrigendum and the 16 e update of the IEEE 802.16 standard, the concept was introduced in which the secondary management connections may have QoS parameters. For example, the secondary management data packets may have such defined parameters as latency and minimum reserved traffic rate. Latency is basically a delay of sending a data packet out to the transmission medium, and the minimum reserved traffic rate indicates the lowest traffic rate guaranteed to those packets in the user service flow. However, these are simply two example QoS parameters that may be defined for the IEEE 802.16 standard. There are many more such QoS parameters which are not discussed here.

Because these various updates of the IEEE 802.16 standard allow such defined QoS parameters to be assigned to the secondary management connections, it is possible to treat the secondary management connections in a similar manner to user service flow connections. From a scheduler perspective, the secondary management connection is treated in a similar manner to the user service flow connection. In other words, the secondary management connection can simply be treated as any other user service flow connection. Secondary management data packets may be placed in the best effort queue of a scheduler in an IEEE 802.16 system, so as to be processed along with other user service flow data packets, or secondary management data packets having defined QoS parameters may be placed in corresponding queues of the scheduler in response to the secondary management data packets having the defined QoS parameters.

Further, although there were no QoS parameters assigned to secondary management connections before the IEEE 802.16 standard updates discussed above, embodiments of the present invention can be implemented in those IEEE 802.16 systems which are not operating according to the updates. In other words, the processing of the secondary management connections described in this application can be implemented on systems operating under the initial IEEE 802.16 standard. In any of the implementations of these IEEE 802.16 systems, the secondary management data packets may be placed in appropriate user service flow queues of the scheduler.

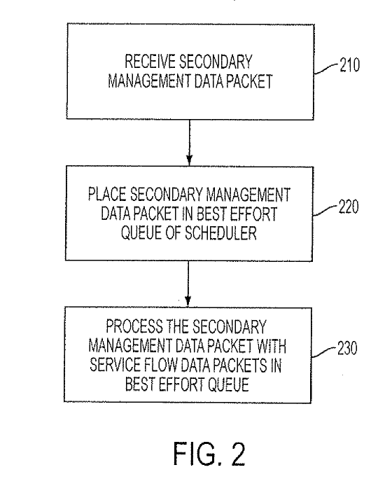

FIG. 2 is a flow chart illustrating one example embodiment of a method including placing a secondary management data packet in a best effort queue of a scheduler in an IEEE 802.16 system, and processing the secondary management data packet accordingly with other data packets in the best effort queue.

In operation 210, a secondary management data packet is received at the scheduler of a node in the IEEE 802.16 system. Every data packet for management connections and user service flow connections has a connection identifier (CID). When the data packet enters the MAC layer it goes through a classification process, and the classification process identifies the packet as to which connection it belongs. Therefore, the secondary management data packet is recognized as such by the scheduler.

In operation 220, the secondary management data packet is placed in the best effort queue of the scheduler. This best effort queue may also have other user service flow data packets awaiting processing, as well as other secondary management data packets previously placed in the scheduler and now awaiting processing. The data packets placed in the best effort queue are typically processed on a first in-first out basis. However, the present invention is not limited to any such embodiment.

Then, in operation 230, the secondary management data packet placed in the best effort queue in operation 220 is processed along with any user service flow data packets also in the best effort queue.

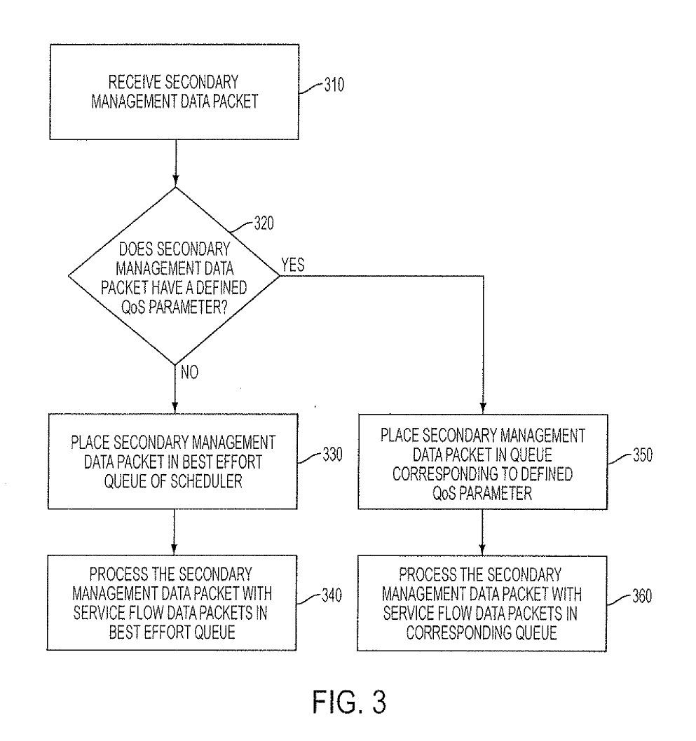

Therefore, because the secondary management data packet is placed in the best effort queue for processing, no secondary management data queue is needed, and a simpler scheduler may be implemented. Further, the processing time of the scheduler may be improved due to not having the extra queue for the secondary management data packets. In the method illustrated in FIG. 2, all secondary management data packets are placed in the best effort queue of a scheduler in an IEEE 802.16 system. However, the present invention is not limited to this embodiment. For instance, the secondary management data packets may be placed in queues of the scheduler according to any defined QoS parameters, as explained in reference to FIG. 3.

The method in FIG. 2 is only an example of a method which includes placing a secondary management data packet in a best effort queue of a scheduler, and the present invention is not limited to this method. For example, there are many variations of the method in FIG. 2 that can be implemented.

FIG. 3 is a flow chart illustrating an alternative embodiment of the present invention, in which the method includes placing a secondary management data packet in a corresponding queue of a scheduler in an IEEE 802.16 system in response to the secondary management data packet having a defined QoS parameter, and processing the secondary management data packet according to the corresponding queue of the scheduler.

In operation 310, as in the previous embodiment, a secondary management data packet is received at the scheduler of a node in the IEEE 802.16 system.

However, in the method illustrated in FIG. 3, it is determined in operation 320 whether the secondary management data packet has a defined QoS parameter. If it is determined in operation 320 that the secondary management data packet does not have a defined QoS parameter, the secondary management data packet is placed in the best effort queue of the scheduler in operation 330.

Then, in operation 340, the secondary management data packet placed in the best effort queue in operation 330 is processed along with any user service flow data packets also in the best effort queue.

However, if it is determined in operation 320 that the secondary management data packet does have a defined QoS parameter, then the secondary management data packet is placed in a queue corresponding to the defined QoS parameter in operation 350. For example, if the defined QoS parameter is a minimum reserved traffic rate parameter, then the corresponding queue is a minimum reserved traffic rate queue of the scheduler. As another example, if the defined QoS parameter is a latency parameter, then the corresponding queue is a latency queue of the scheduler. These are merely two examples of the many defined QoS parameters possible in an IEEE 802.16 system, and the present invention is not limited to these discussed parameters.

After the secondary management data packet is placed in the corresponding queue in operation 350, the secondary management data packet is processed along with any other user service flow data packets in that corresponding queue in operation 360.

Therefore, in the embodiment of the present invention illustrated in FIG. 3, a secondary management data packet having a defined QoS parameter is able to be scheduled according to that parameter. In the conventional system, even if a secondary management data packet did have a defined QoS parameter, that secondary management data packet would go to a secondary management queue. However, in embodiments of the present invention, a method of processing secondary management data packet includes processing each of the secondary management data packet through one or more queues in a scheduler used to process a user service flow in an IEEE 802.16 system.

The method in FIG. 3 is only an example of a method which includes placing a secondary management data packet in a corresponding queue of a scheduler, and the present invention is not limited to this method. For example, there are many variations of the method in FIG. 3 that can be implemented.

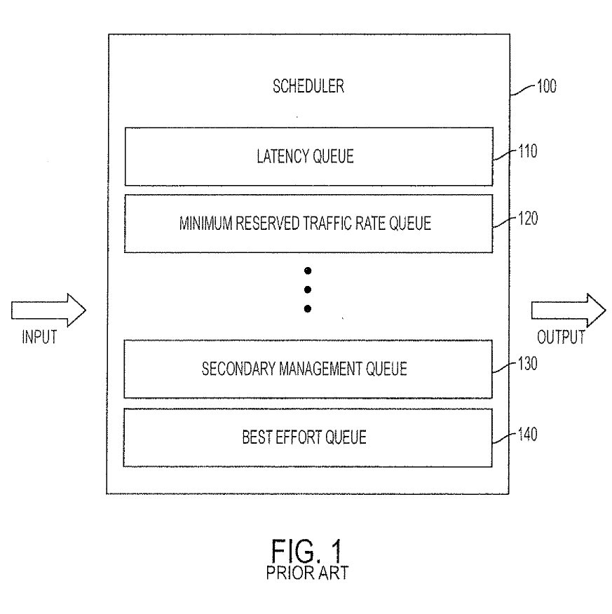

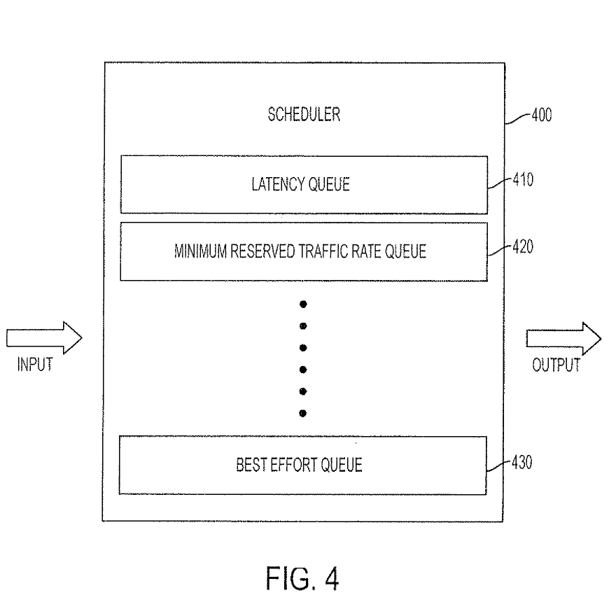

FIG. 4 illustrates a scheduler 400 for a IEEE 802.16 implementation according to an embodiment of the present invention. Similar to the scheduler 100 illustrated in FIG. 1, the scheduler 400 has a latency queue 410, minimum reserved traffic rate queue 420, and best effort queue 430. This figure does not attempt to illustrate all of the queues included in the scheduler 400.

For instance, the scheduler 400 may also include several other queues corresponding to QoS parameters, such as jitter, as well as basic and primary management queues, and is not limited to the queues shown. However, it is noted that the scheduler does not include a secondary management data queue.

As shown in FIG. 4, the scheduler 400 includes the best effort queue 430 in which user service flow data packet having no defined QoS parameters are placed in an IEEE 802.16 system, and a secondary management data packet may be placed in the best effort queue 430 and processed accordingly with the user service flow data packets in the best effort queue 430.

Alternatively, since, as shown in FIG. 4, the scheduler 400 includes a plurality of QoS specific queues to process data packets having defined QoS parameters in an IEEE 802.16 system, a secondary management data packet may be placed in a corresponding queue of the scheduler in response to the secondary management data packet having a defined QoS parameter. In other words, for example, the secondary management data packet may be placed in the minimum reserved traffic rate queue 420 in response to having a defined minimum reserved traffic rate parameter. As another example, the secondary management data packet may be placed in the latency queue 410 in response to having a defined latency parameter Since this implementation is possible for any QoS parameter that might be defined for user service flow data packets, either now or in the future, any secondary management data packets having one of those defined QoS parameters may be treated in a like manner without further adaptation. In other words, the invention makes it easier to implement support for any new QoS parameters added by the IEEE 802.16 standard, because the same mechanism as developed for the user service flows may be used to process the secondary management connections to support these new parameters.

If the secondary management data packet does not have a defined QoS parameter, that secondary management data packet may be placed in the best effort queue 430 of the scheduler 400.

In other words, the number of queues is reduced in a scheduler of an IEEE 802.16 system according to an embodiment of the present invention. Therefore, the complication of having a higher number of queues, such as extra processing time, may be avoided. Also, QoS parameters defined in the secondary management data packets may be used as intended. For example, in the conventional system a secondary management data packet may be placed in the secondary management queue even if the secondary management data packet had a defined latency parameter, and there would be the danger that the latency parameter would not be satisfied because the secondary management queue is at a lower priority than the latency queue. However, a scheduler according to an embodiment of the present invention includes a plurality of queues to process a user service flow in an IEEE 802.16 system, and one or more secondary management data packets may each be processed through one or more of the queues which process the user service flow. Therefore, along with the benefit of less complexity and processing time of the scheduler, any defined QoS parameters of secondary management data packets may also be satisfied.

FIG. 4 is only one example of a scheduler, and the present invention is not limited to the specific embodiment in FIG. 4, Instead, there are many variations of the example in FIG. 4 which can be implemented.

Embodiments of the present invention are applicable to an IEEE 802.16 system, which includes system defined by IEEE 802.16 and all amendments and extensions to 802.16. However, the present invention is not limited to an IEEE 802.16 system, and can be applied to other systems which use a scheduler.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method, comprising:
placing a secondary management data packet in a best effort queue of a scheduler in an Institute of Electrical and Electronics Engineers (IEEE) 802.16 system; and
processing the secondary management data packet accordingly with other data packets in the best effort queue.

2. A method, comprising:
placing a secondary management data packet in a corresponding queue of a scheduler in an Institute of Electrical and Electronics Engineers (IEEE) 802.16 system in response to the secondary management data packet having a defined quality of service (QoS) parameter; and
processing the secondary management data packet according to the corresponding queue of the scheduler.

3. The method of claim 2, wherein the defined QoS parameter is a minimum reserved traffic rate parameter, and the corresponding queue is a minimum reserved traffic rate queue of the scheduler.

4. The method of claim 2, wherein the defined QoS parameter is a latency parameter, and the corresponding queue is a latency queue of the scheduler.

5. The method of claim 2, wherein the secondary management data packet is placed in a best effort queue of the scheduler in response to the secondary management data packet not having a defined QoS parameter.

6. A method of processing secondary management data packets comprising:
processing each of the secondary management data packets through one or more queues in a scheduler used to process a user service flow in an Institute of Electrical and Electronics Engineers (IEEE) 802.16 system.

7. A scheduler, comprising:
a best effort queue in which service flow data packets having no defined quality of service (QoS) parameters are placed in an Institute of Electrical and Electronics Engineers (IEEE) 802.16 system;
wherein a secondary management data packet is placed in the best effort queue and processed accordingly with the service flow data packets in the best effort queue.

8. A scheduler, comprising
a plurality of quality of service (QoS) specific queues to process data packets having defined QoS parameters in an Institute of Electrical and Electronics Engineers (IEEE) 802.16 system;
wherein a secondary management data packet is placed in a corresponding queue of the scheduler in response to the secondary management data packet having a defined QoS parameter.

9. The scheduler of claim 8, wherein the plurality of QoS specific queues includes a minimum reserved traffic rate queue, and the secondary management data packet is placed in the minimum reserved traffic rate queue in response to having a defined minimum reserved traffic rate parameter.

10. The scheduler of claim 8, wherein the plurality of QoS specific queues includes a latency queue, and the secondary management data packet is placed in the latency queue in response to having a defined latency parameter.

11. The scheduler of claim 8, further comprising a best effort queue to process data packets having no defined QoS parameters, wherein the secondary management data packet is placed in the best effort queue in response to not having a defined QoS parameter.

12. A scheduler, comprising:
a plurality of queues to process a user service flow in an Institute of Electrical and Electronics Engineers (IEEE) 802.16 system;
wherein one or more secondary management data packets are each processed through one or more of the queues which process the user service flow.
